(19) United States
(12) Patent Application Publication
(10) Pub. No.: US 2001/0035880 A1
(43) Pub. Date: Nov. 1, 2001

(54) Interactive touch screen map device

(76) Inventors: Igor Musatov, Newport News, VA (US); Vladimir Popov, Newport News, VA (US); Vladimir Serov, Newport News, VA (US)

Correspondence Address: Igor Musatov, Lintech Inc, 804 Middle Ground Blvd., Newport News, VA, 23606, US

(21) Appl. No.: 09/798,976

(22) Filed: Mar. 6, 2001

Related U.S. Application Data
(60) Provisional application No. 60/187,017, filed on Mar. 6, 2000.

(51) Int. Cl. G06F 3/00

(52) U.S. Cl. 345/764; 345/835

(57) ABSTRACT

A mobile or hand held computer system with a touch screen graphical display functions as a programmable interactive touch screen map. It shows an image representing a map and allows a user to enter a map location by pressing corresponding point on the touch screen. The video memory associated with the map image also contains transparent interactive objects, whose shapes and positions corresponds to visual feature on the map. Each of the interactive objects is described by a record in a data base, the record contains textual, visual, audio information and reference to a computer algorithm. If a location, entered by user falls within an interactive object, corresponding record is accessed, relevant algorithm is executed and the information from the is provided. An intuitive graphical user interface includes, beside the interactive map, information and control section which allows user to enter commands and obtain information.

### BACKGROUND OF THE INVENTION

The present invention relates generally to the computerized map devices and, more particularly, to a method and apparatus for providing a device presenting computerized sensitive map with embedded interactive objects and intuitive touch screen interface.

Mobile and hand held computer devices with high quality graphic interfaces provide a platform for applications used for various tasks such as navigation, communication, mobile data entry, etc. Specific features of said devices and application are the user interface methods. The choice of the user interface methods and controls is limited to those which are practical to the operational and environmental conditions of the mobile applications, in contrast to the office and similar stationary computer devices. Usually, said methods should be more simple and intuitive than those for the stationary computers. For example, standard typewriter keyboard or mouse are not acceptable for hand held and for the most of mobile computer devices. Similarly, output devices and methods should present the information in audio and in the most intuitive visual or graphical form.

The well known touch screen visual or graphic interface is the two way communication device, which provide one of the most natural methods of communication between an operator and a hand held or mobile computer device.

Additional advantage of the touch screen graphic interface is its flexibility. Compared to a control with the hardware keys, which is fixed for a given device, the controls on the touch screen are programmable. Consequently, the number, look and functions of the control elements on a touch screen may be programmed differently on the same device for different tasks, functions or applications.

The concept of a generalized graphic user interface led to the development of a standardized protocol for an abstract device, graphic terminal. The latter consists of a graphic visualization device (display or monitor), keyboard and one or more pointing devices. X-protocol was developed by X Consortium, and become a standard for communication between one or more computers with a X terminal. Some modified versions of the X protocol were implemented by Microsoft (different versions of Windows(™) ) and Apple. A layer of abstraction, a concept of so-called , was introduced. Generally, X event is either any of the instances when signal from a user input device is received, or the status of a visual object is changed. For example, key input or pointer movement is a user generated X event; an object becoming visible, moved or destroyed is a computer generated X event. The concept of X events provides a way of a unified approach to building graphic user interface.

Different programming languages and programming tools (tcl/tk, Java, qt etc.) have special features to operate with graphic objects in X interface and process X events. A common approach is to use a concept of “objects”, which are defined (for the purpose of visualization) as specific elements of visual interface, each having its specific visual attributes or properties. Special type of objects is a “window” object, which contains a logical block of the interface and, in turn, may contain other objects.

Said programming languages and tools include algorithms and methods to process as related to either a visual interface as a whole or to a particular object (or set of objects) in the interface. For example, a pointer-generated X event, pressing mouse button while X pointer placed over an object in a window, may be processed independently as an event related to the whole interface, to the window or to the object. Other important operations, embedded in the programming languages and tools, include effective algorithms for creating, destroying, restoring, moving objects; special algorithms for processing overlapping objects; identifying the condition of a X pointer (cursor) to move into (or out) a particular object. Each object of a visual interface is controlled by one or more computer algorithms.

Programming tools and algorithms for different languages are available which allow simple interface for drawing simple -dimensional figures, such as lines, circles and polygons.

Special algorithms are developed to effectively process, store and display on a computer monitor motion pictures; similar tools exist for processing, storing and playing sound. There several types of standards for storing video and sound for motion pictures (MPEG, QuickTime etc.) and audio files.

Availability of the high quality graphic interface makes it possible to provide geographic and other maps as computer generated images and with associated computer algorithms which provide operator (user) with a way to control displaying the maps and other relevant information. For example, navigational street map are associated with an address and geographic coordinate database, so that for a given street address, corresponding computer program displays a map for relevant region in the desired scale and marks the location. Additional programmable graphic elements of the interface, such as buttons, are used as an intuitive control interface for the computer program. Some elements or features may be marked on the map with icon-like images and thus provide interactive objects on the map.

The navigational task of identifying on the map of a specific location, given by its address or similar properties, is solved by using a data base, which associated the addresses or geographic coordinates to the visual (or “screen”) coordinates or elements on the visual map. For coordinate translation a simple translation algorithm can be used.

The reverse navigational task, the associating visual elements or “screen” coordinates to the corresponding objects, is a more complicated problem. The reason is that for a map, visualized as an image on a computer display, relating each pixel to the corresponding object or objects would impose a large memory and other computing resource requirements and is practically not feasible.

A method of using a color indexing was suggested in U.S. Pat. No. 4,847,604. With this method, each object on the map is marked with a specific color, and the numerical presentation of the display color serves as the object identification. This method requires a special coloring for the map features and therefore does not apply to a high quality graphical map, such as an aerial photo.

Another way of marking objects is implemented in HTML language as the “area” map. This method associates a visual map, which is a “picture” element of a HTML-document, to a set of “areas”. Each “area” element is a geometrical 2-dimensional figure, defined by its screen coordinates relevant to the image map. A reference to a URL resource is associated with each “area”. As a result, visual features or object of the visual map get associated with corresponding documents or algorithms.

High quality graphic interface for mobile or hand held devices provides a platform for using computer generated maps for mobile navigational applications. The task of between a mobile device and a stationary device or network, or among several mobile devices requires wireless communicational methods. The most common method for wireless communication is radio communication. Several types of radio communication are used for mobile or hand held applications, depending on the technical requirements for a particular application, such as speed of data transfer, range or reliability. The computer software for communication is available and includes standard tools and protocols, such as “telnet” and “ftp”, and provides a way to remotely control operation of a computer device through communicational channel, or to transfer information to and from a remote computer device. This allows to change maps, associated with them data and the operation algorithms of the device remotely. To provide such a functionality, the computer device should include the software algorithms allowing remote access or data transfer. This software is available for multiple computer platforms and usually included in the standard set of programs with the operating system, such as any type of UNIX, BSD or Linux.

One of the most common navigational tasks is a problem of positioning a device (vehicle) on the geographic map. Global Positioning System, GPS, provides a method of positioning based on the measuring parameters of signals from special satellites. The accuracy of the GPS positioning is sufficient for most of navigational application, and may be improved with using DGPS correction technology. There is a variety of GPS devices and systems, such as Trimble, Magellan, which communicate with the computer via standard protocols.

### SUMMARY OF THE INVENTION

The primary object of the present invention is to provide a method and apparatus for a programmable mobile or hand held interactive electronic maps with a touch screen graphical user interface.

Other objects and advantages of the present invention will become apparent from the following descriptions, taken in connection with the accompanying drawings, wherein, by way of illustration and example, an embodiment of the present invention is disclosed.

The device is a computer incorporating a processor unit, data storage and integrated display and touch screen, and contains programs and data provide sensitive interactive map functionality. The interactive map is a touch screen-based graphical user interface which includes interactive map with interactive map objects and other control elements. The number, appearance and functions associated with said control elements are specific for a particular application or function performed by the device.

Interactive map objects are either icon-like pictures displayed over the map image or invisible transparent figures placed over map features. The computer software includes a data base of the interactive map objects. The data base associates algorithms and data with the interactive objects. The algorithms are executed when related to the object X-event occurs, i.e. when user touches an interactive object or the current location marker moves over an interactive object.

The interface allows to enter locations on the map; shows current location of the device; measures distances between current location and entered location, between different entered locations, between entered location and some fixed locations; shows information about specified objects on the map; execute computer algorithms specific for particular locations and objects; communicate with other computer devices, send and receive text messages; display text messages in interactive windows; allows user to enter specific commands and obtain additional textual, visual and audio information. In the preferred embodiment, the device has a capability of identifying its location through Global Positioning System and show said location on the interactive map.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a top perspective view of an interactive touch screen map device embodying features of the present invention.

FIG. 2 is a schematic block diagram of the interactive touch screen map device of FIG. 1.

FIG. 3 illustrates a screen capable of being shown on the touch screen display of FIG. 1.

FIG. 4 illustrates the concept of the transparent interactive objects superimposed on the high quality graphical map. The map is shown in the lower portion of the FIG. 4, and corresponding interactive objects are shown as contours on the separate layers above the map layer.

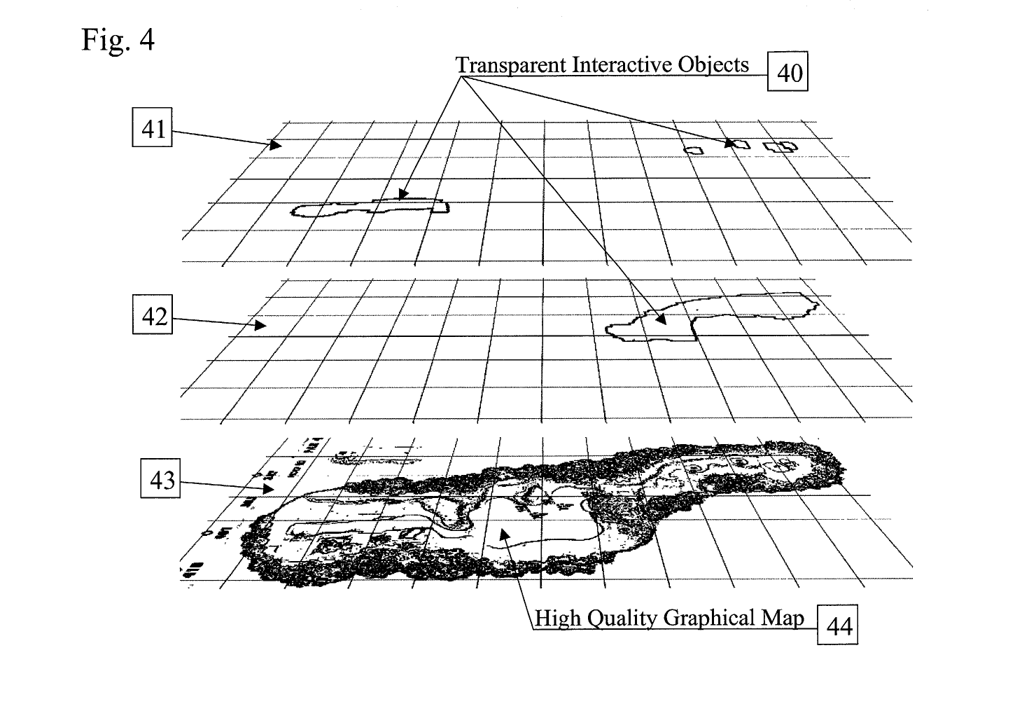

FIG. 5 illustrates an example of a screen image of an interactive touch screen map device, showing the portions of the screen with the textual data and operator controls, and the high quality graphical map with the transparent interactive objects superimposed.

FIG. 6 is an illustration of a computer programming tool for associating of the objects on the map with the transparent interactive objects.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### BRIEF DESCRIPTION OF THE INVENTION

The descriptions which follow are presented largely in terms of display images, algorithms, and symbolic representations of operations of graphical objects within a computer memory. These algorithmic descriptions and representations are the means used by those skilled in the data processing arts to most effectively convey the substance of their work to others skilled in the art. An algorithm is here, and generally, conceived to be a consistent sequence of steps leading to a desired result. These steps are those requiring physical manipulations of physical quantities. Usually, though not necessarily, these quantities take the form of electrical or magnetic signals capable of being stored, transferred, combined, compared, selected, chosen, modified, and otherwise manipulated. It proves convenient at times, principally for reasons of common usage, to refer to these signals as bits, values, elements, symbols, characters, images, terms, numbers, or the like. It should be borne in mind, however, that all of these, as well as similar terms, are to be associated with the appropriate physical quantities and are merely convenient labels applied to these quantities. In the present case, the operations are machine operations performed in conjunction with a human operator. Useful machines for performing the operations of the present invention include general purpose digital computers or other similar devices. In all cases, the distinction between the method operations of operating a computer and the method of computation itself should be kept in mind. The present invention relates to method steps for operating a computer and processing electrical or other physical signals to generate other desired physical signals.

The present invention also relates to apparatus for performing these operations. This apparatus may be specially constructed for the required purposes or it may comprise a general purpose computer selectively activated or re configured by a computer program stored in the computer. The algorithms presented herein are not inherently related to any particular computer or other apparatus. In particular, various general purpose maps may be used with programs in accordance with the teachings herein, or it may prove more convenient to construct more specialized apparatus to perform the required method steps. The required structure for a variety of these mapping applications will appear from the description given below. Machines which may perform the functions of the present invention include those which operate under the same computer algorithms and conventional protocols. Similarly, the same operation are performed by different brands of the operating system software, regardless of the specific hardware platform or particular operating system.

### System Overview

The system of the present invention differs significantly from prior art computer map systems since it is based upon modular object-oriented software and event-driven algorithms. The object-oriented software event-driven algorithms with provides features previously not available in prior art computer map systems. The main advantage of the present invention is the method of identifying or marking the objects on a map without interference with the appearance of the map, so that high quality graphical pictures, such as aerial photos, may be used. This is achieved by means of the transparent (and therefore invisible) interactive objects overlaying the corresponding map features, and associating with each of the transparent interactive object a data base entry with related information and computer algorithms. The event-driven algorithm concept provides a platform for designing the computer program as a set of independent blocks, each of said blocks becomes operational upon occurrence of a specified in the algorithm event. For example, when an operator (sometime referred to herein as a “user”) touches a visual object (feature) on the touch screen map, an X-event related to the transparent object overlaying said visual object is generated, and the associated with the object information and computer algorithm (“function”) from the data base are accessed; said algorithm is executed by the computer and the relevant information is displayed on the screen.

It must be noted that the features of the present invention are illustrated in black and white within the accompanying figures. However, in the presently preferred embodiment, and as described below, objects and features are displayed in color with high quality graphics. Some of the interactive objects, including their contours, are filled with “transparent” color and therefore invisible, but with the purpose of illustration, they with black contours.

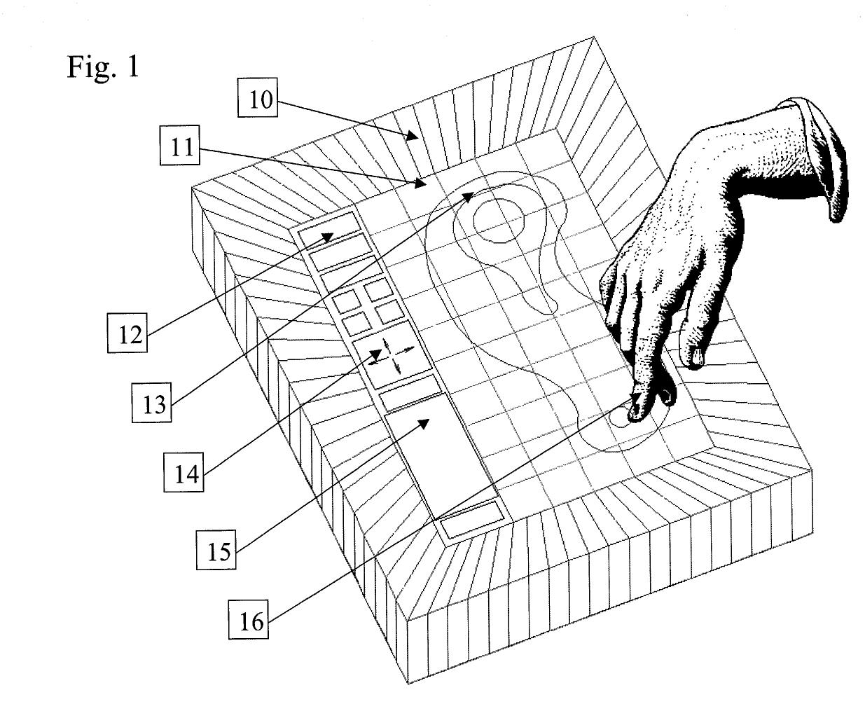

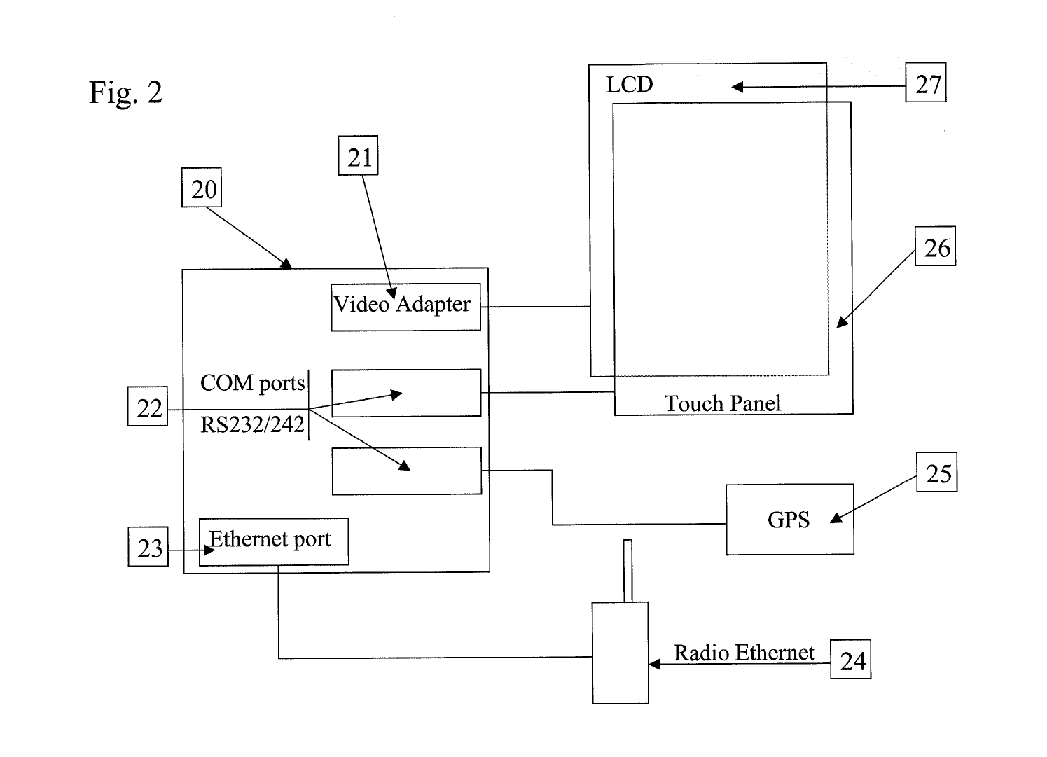

FIG. 1.a illustrates a general appearance of the preferred embodiment of the present invention. A single mobile or hand held case 10 incorporates the computer with a main processor unit 20, which includes data storage, and communicational 22,23 and positioning 25 electronic equipment. The main processor unit comprises a central processor, memory, video generating circuit and video output 21, sound generating circuit with sound playing device, such as speakers, and communicational circuits 22 for connecting various peripheral devices. The logical scheme of the connection of computer unit is shown in FIG. 2. One panel of the device comprises an integrated high quality graphical touch screen display 11, as shown in FIG. 1. The display 11 comprises, in part, a color raster display device 27 such as a liquid crystal display (LCD). The display 11 must be of sufficient resolution such that display 11 can render graphic images. In the preferred embodiment, the display 11 further comprises a touch screen display 26 system. The touch screen display includes a feature that can detect the presence of a finger 16 touching the display screen 11. location of the finger 16 touching the display screen 11 such that the display screen can sense finger gestures made by a user's finger on the display screen 11. The touch screen display 11 may comprise one of a variety of touch sensitive display screens commercially available on the market. The touch screen display is coupled to the main processor unit via input/output communicational circuits 22. These elements are those typically found in most mobile or hand held touch screen computers, and in fact, the hand held computer system 10 is intended to be representative of a broad category of hand held or mobile computer devices.

A radio network device 24, which provides communication of the touch screen map device with other computer devices, is connected to the computer network interface 23 of the main processor unit 20.

A positioning device 25 is coupled to the main processor 20 unit via a standard communicational port 22. The positioning device is one of the common Global market. The positioning device is capable of identifying its location in terms of the global geographic coordinates, using radio signals from the satellites of GPS system.

A block diagram of the scheme for connecting peripheral devices to the main computer unit is shown in FIG. 2.

The device is controlled by a UNIX- type operating system. The operating system provides necessary algorithms and programs for controlling and communication with peripheral devices.

The software includes a standard “X-server” application, which is configured to use the touch screen panel as a pointing device; there is no additional “window manager” or “desk top” application.

The computer code or algorithms for said operating system, X-server and communication functions is not disclosed herein since the description of the present invention in this Specification is sufficient for one skilled in the computer art to utilize the teachings of the invention in a variety of computer systems using one of many computer languages. Similarly, the structure of the data base for interactive objects and relevant algorithms and programming tools are not disclosed, since a variety of known data base management systems is available.

### Coding Details

No particular programming language has been indicated for carrying out the various procedures described herein. This is due in part to the fact that not all languages that might be mentioned are universally available. Each designer of a particular touch screen map device will be aware of a language which is most suitable for his immediate purposes. In practice, it has proven useful to substantially implement the present invention in a high level language. Because the computers and the monitor systems which may be used in practicing the instant invention consist of many diverse elements, no detailed program listing has been provided. It is considered that the operations and other procedures described herein and illustrated in the accompanying drawings are sufficiently disclosed to permit one of ordinary skill to practice the instant invention.

### DETAILED DESCRIPTION OF THE INVENTION

A computer based touch screen map with an intuitive graphical user interface is disclosed. In the following description, for purposes of explanation, specific nomenclature is set forth to provide a thorough understanding of the present invention. However, it will be apparent to one skilled in the art that these specific details are not required to practice the present invention. In other instances, well known circuits, functions, processes, and devices are shown in block diagram and conceptual diagram form in order not to obscure the present invention unnecessarily.

In the description of operation of the device of the present invention, we refer to the process of interacting with the touch screen as “touch”, and refer to a pointer as “finger”, though other pointers and other means of interaction may be implemented.

### Description of the Interactive Map Interface.

The touch screen map device may enter several different operational modes. The set of operational modes, specific operational mode features or operational details are application-specific and not covered by the present invention. The present invention provides the platform for designing the functionality of the device in the “interactive touch screen map” mode (to as “main operational mode”). Additional auxiliary modes of operation may be added as necessary for a particular application to provide a mechanism for additional functionality such as data entry, messaging and other similar functions. Different operational modes may be invoked either by user, by means of the touch screen display control elements through the mechanism of; or by a computer generated event such as a file event, timer event, incoming message event.

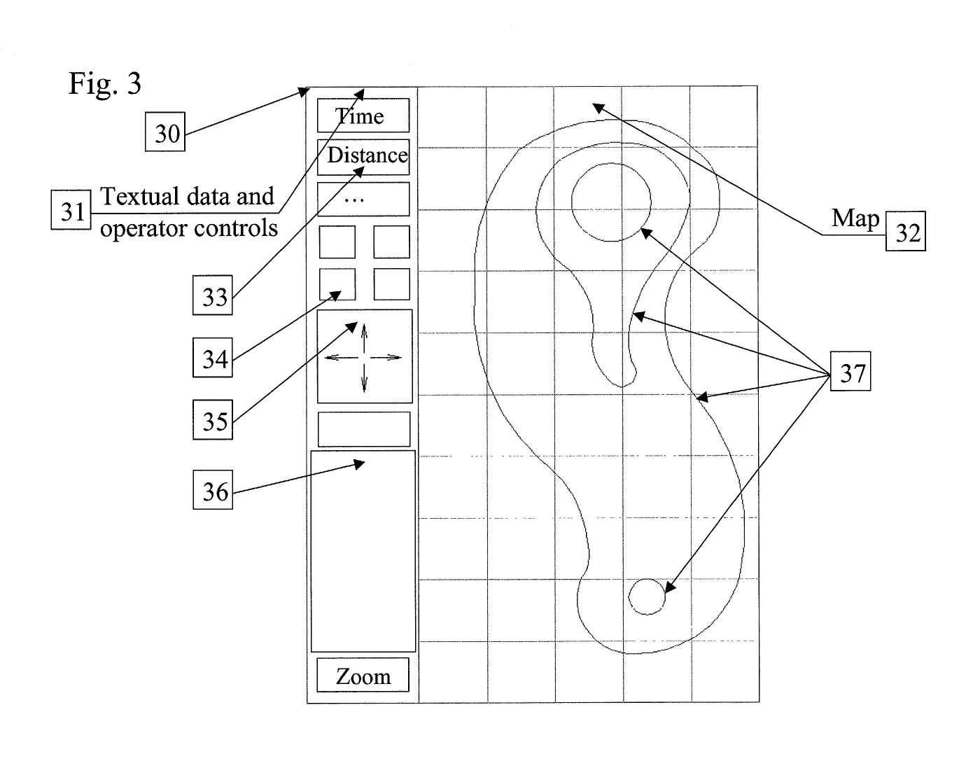

In the main operational mode, user interface provides two functionally different sections, as shown in FIG. 3:

1) interactive map 32; and 2) information and control panel 30.

The information and control panel consists of informational (“passive”) elements 33 and control elements (“buttons”) 34,35, with textual or visual information in each element. The control elements differ from informational elements in that the control elements are bound to the touch screen pointer events; when user touches a control element, corresponding algorithm is invoked, changing the operational mode or sub-mode.

The interactive map section 32 includes map image 37,44 with interactive elements 40. The interactive elements are either icon-like images or transparent, and therefore invisible, programmable objects whose placement and shapes corresponds to the features of the map. The transparent interactive objects correspond in shapes and placement to visual features of the map. The map image and interactive elements are bound to the touch screen in the way similar to the event bindings of the control elements of the control section and described in details below. There is a stack 41,42 of the objects 40 in the interactive map section, with the map image 44 as the lowest element 43 in the stack, and other elements 40 have a pre described order in the stack.

The purpose of the predefined order is twofold:

1) the visible elements are ordered in the way that the upper element partially or completely screens the elements below, therefore designer should consider which elements should be in a particular layer; and

2) for both visible and invisible (transparent) elements, the effect of such overlay is that “touching” the touch screen at the point where more than one interactive elements are located, the X-event will carry the attributes of the upper element. Therefore, in the designing the scheme for the set of the interactive elements, designer should define the hierarchies of the interactive elements, separately for each interactive map operational mode.

Particular scheme of the bindings is designed for a touch screen map application depending on the specific tasks performed by the device.

The touch screen bindings in the following description are found to be generally necessary and useful for an application of the interactive touch screen map device. The bindings are described in the following order: for each X-object, most general bindings are given first for the main operational mode, and then for additional modes or sub-modes, if different from the general bindings.

The procedure for processing the events other than are described separately.

Type of X-event, related to the interactive map section, may be one of the following:

“touch”—for the event generated by finger pressing and holding the touch screen;

“move”—for the event generated by moving finger while continuously touching the touch screen;

“release”—for the event of the removing finger from the touch screen;

“double touch”—for the event, consisting of the touching the screen for a short period of time, releasing for short period of time and touching again at approximately the same pixel location. The definition of the time periods and proximity of the second touch is a parameter of the X-interface and may be adjusted for a particular application as necessary.

The X-event may have the following attributes which available for the analysis in the computer algorithm, bound to the event:

“window name”—for the control section elements, it is the name of control section window; for the event of touching the interactive map section, it is the name of the interactive map section window.

“coordinates”—the coordinates in the format and units as reported by the touch screen device through the X-interface, in relation to the axes origin of the relevant window;

“object”—the identification of one or more of the following:

the map image, interactive object (transparent or visible), marker.

“object attributes”—special attributes of the object, such as the class or type name of the object, individual name of the object, associated image or other visual element, coordinates associated with the object, current status of the object, reference to the data base entry for the object.

The description of the X-event binding scheme for the interactive map section of the interface and its elements is disclosed, for main operational mode and its modifications, referred to as “sub-modes”.

The format of the description is the following:

“Mode or sub-mode:

Object:

X-event-algorithm”

X-event, related to the interactive map section:

the interactive map section as a whole:

general mode:

touch—cursor (pointer) appears;

move—cursor moves;

release—cursor is destroyed.

location mode:

touch—cursor (pointer) appears,

coordinates of the cursor are displayed;

move—cursor moves,

coordinates of the cursor are displayed;

release—coordinates of the cursor are displayed,

cursor is destroyed,

marker at the last cursor location is drawn;

Transparent or icon-like object bindings:

touch or move-in: the information on the object in the data base is accessed and relevant items are displayed;

release—algorithm referred to the object in the object data base is started.

The communicational device and blocks of information on the data storage, within the operating system functionality, are logically equivalent and referred to as “files”. The change of status of the file generates a “file-event”.

File event bindings:

GPS location—move the “current location” marker to the position provided by the GPS;

check if new coordinates are within an interactive objects, and if yes, generate relevant X-event.

incoming message starts—message processing algorithm

Timer event:

start algorithms scheduled for the current time, such as background processes or alarms.

### Description of Operation

The device enters main operation mode on the power-up or, alternatively, from one of the auxiliary modes. The following operations are performed by the algorithm: creating the information and control section, with information, control and image-video elements and corresponding bindings; creating the interactive map section, including setting X-event bindings for control elements; setting the file, timer and other external event bindings.

The algorithm creating the interactive map section performs the following steps: defines which section of the map and in what should be displayed; imports the image of the map from the storage device and places it in the interactive map section; sets the interactive map section event bindings; defines which interactive and non-interactive map elements are associated with current map image; places the relevant element in the order, from lower to upper level order, setting bindings for each interactive element. Then, relevant information is shown in the information parts of the control and information section.

The operation of the device after that stage is determined by the algorithms bound to the events. As an event occurs, the corresponding algorithm is invoked. In course of the algorithm execution, the device may either enter a different operational mode, or may remain in the same operational mode after completing execution of said algorithm.

The operation of the device in auxiliary modes, which are not an interactive touch screen mode, are not disclosed as they are based on the previously known methods and algorithms.

### Description of Sample Operation

The present invention provides the platform for programmable interactive map which may be used as a component part of the process of computations necessary for a particular application.

As an example of using the interactive touch screen map in the preferred embodiment for a particular application, we describe the algorithms and methods of the main operational mode for application in a golf gaming device. This application is chosen for the reason that the purpose of the device is easy to understand for a general person and does not required special skills or knowledge of the field of application.

It should be noted that the operation of the device as a golf course map is given as an example for the purpose of better understanding the processes involved in designing the interactive touch screen map for a specific application. The same computer device may be used for another interactive map application after changing or replacing the data in the storage device. The relevant data are: the set of image maps, interactive objects, associated algorithms and data base records, set of information and control elements of the information and control section.

The device enters the main operational mode either after player (“user”) initiates it by touching corresponding control element on the touch screen, or as a result of execution of an algorithm bound to the GPS-generated event, when the coordinates of current location are found to fall within a particular area, for which the device is programmed to serve as a golf course map. The algorithm finds which map should be displayed, then loads the image from the storage device to the memory, generates information and control section, generates interactive map section and displays the map image, reads the data base and defines which records are related to the objects associated with said map, creates the interactive objects and binds all control element events with their respective algorithms. The images or motion pictures (instruction and recommendation for player related to the shown map or advertisement) are shown in the image, sound records associated with the map are played through audio playing device.

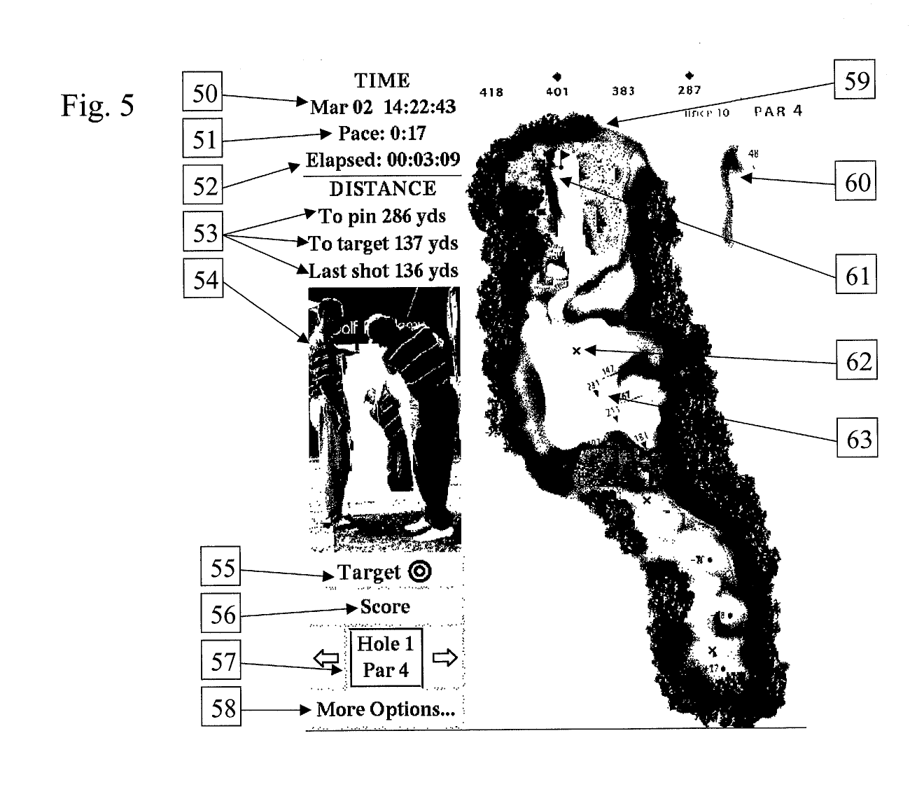

A sample design of the interface is shown in FIG. 5.

The following invisible transparent objects are placed over the map image: a number of “tee-off” elements, corresponding the tee-off spots on the map, “rough:, “green”, “sand”, “water”. The X-event bindings for each of the elements are specified in process of the designing the particular golf course application; the process is described below.

For the purpose of the explanation we provide a description of a sample scheme of event bindings. The interactive map, within the main operational mode, may be in one of the sub-mode operational states, the sub-modes differ in the way some of the X-event bindings are defined for the interactive elements.

X-event, related to the interactive map section 59 for the main operational mode are identical to those disclosed in the “Description of the invention” section. There are different bindings for the sub-modes. There are the following sub-modes of the main operational mode: “start”, “tee-off”, “first shot”, “target”.

We describe here only differences of X-event bindings from the “standard” (given for the “general” mode) for each sub-mode. If bindings are not described, it means no bindings are defined.

The objects are drawn, if not specified otherwise, at the position given by the X-event coordinates. If the object is said to be replaced with another, it is destroyed and then another object is drawn at the same position. The different types of icon-like pictures are used as “markers” 62, 63 to point the locations, and their meanings should be known to operator.

“General” mode:

interactive map section 59:

touch—cursor (pointer) appears;

move—cursor moves;

release—cursor is destroyed.

“Start” sub-mode:

Only “tee-off” transparent interactive objects have bindings to the:

release—the marker “ball, tee-off position” is drawn at the X-event coordinates;

memorize the identificator of the tee-off object;

switch to the “tee-off” sub-mode;

“Tee-off” sub-mode:

interactive map section:

touch—cursor (pointer) appears;

move—cursor moves;

release—cursor is destroyed, the marker “ball, current position” 62 is drawn. Distances from this marker to the marker “ball, tee-off” and to pin are displayed in the information section.

The mode is switched to “First shot” sub-mode.

tee-off transparent objects:

for tee-off object with the identificator memorized during “Start” or last Tee-off” sub-mode sub-mode, no X-event bindings;

other tee-off transparent objects:

release—the marker “ball, tee-off position” is destroyed and drawn;

forget previous tee-off object identificator;

memorize the id of the tee-off object;

switch to the “tee-off” sub-mode;

“First shot” sub-mode:

interactive map section:

release—cursor is destroyed, the marker “ball, current position” is destroyed (if exists) and drawn. The marker “ball, tee-off” is replaced with the marker“ball, last position”.

Distances from this marker to the marker “ball, last position” and to pin are displayed in the information section.

tee-off transparent objects:

no X-event bindings;

all other transparent objects except “Green”:

release—start algorithm “instructions”;

The “Target” sub-mode is invoked by operator pressing “Target” button 55 in the control section. The marker “ball, current position” is replaced by marker “ball, last position”.

“Target” sub-mode:

interactive map section:

release—cursor is destroyed, the marker “ball, current position” is replaced . The marker “ball, tee-off” is replaced with the marker “ball, last position”.

Distances from this marker to the marker “ball, last position” and to pin are displayed in the information section.

“Green” transparent objects:

release—switch to the “Show Green” mode. The map in the interactive map section is replaced by the larger scale map of the “Green” area and other actions specified for the “Green” mode are performed.

all other transparent objects except “Tee-off”:

release—start algorithm “instructions”;

File event bindings:

GPS location—move the “current location” marker to the position provided by the GPS; check if new coordinates are within an interactive objects, and if yes, generate relevant X-event; if the GPS coordinates are beyond the area of the current map and fall into the area of another existing in the storage device map, change the map as appropriate and switch to the “Start” sub-mode.

incoming message—start message processing algorithm

Timer event:

change advertisement image or start movie in the advertisement window 54, send message with current GPS coordinates to the golf club server.

Buttons in the control section are programmed to switch the device to auxiliary operational modes or to change the map in the interactive map section.

### Preparing Maps for Using in Sample Device

Special software (“map editor”) is used to prepare the interactive map and other related data for the interactive touch screen map device. A general purpose computer may be used for this application. The computer should have the capability to provide X-protocol functionality and include graphics processing programming tools. A variety of the platforms are available, and the choice of the computer architecture and programming languages and tools is determined by particular application. Known algorithms and methods may be used to design the program for interactive map processing, following the description of present invention.

The map editor program must perform the following operations:

create and edit the general configuration data for the application;

associating graphical maps with geographical coordinate system;

creating and placing interactive and non-interactive objects on the map within specific layers;

provide identification and other attributes for interactive objects in according with the classification accepted for the application;

provide event bindings for interactive objects with the names of the corresponding algorithms and functions.

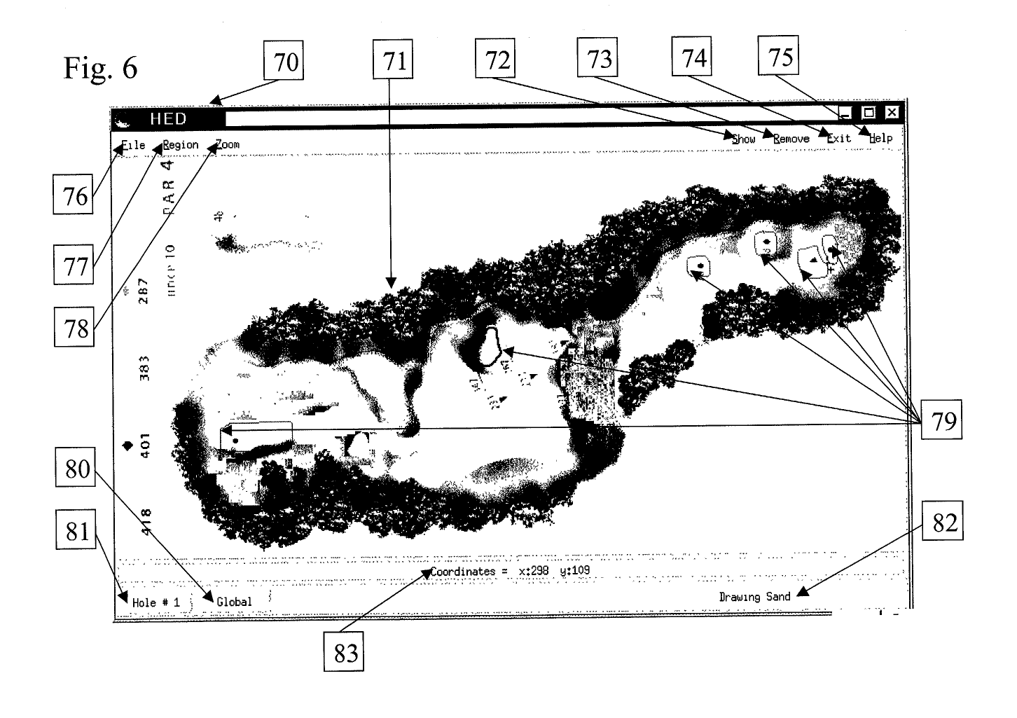

The resulting data are placed in the data base in the format used by the interactive map device. The map editor program includes the graphical user interface FIG. 6. The main window 71 of said interface 70 displays a graphical map. The menu buttons are used in the way common for a user graphic interface. A commonly known algorithm [see, for example, ] is used to draw a closed contours. Operator draws a closed contour 79 around a feature on the graphical map using a pointing device such as a computer mouse. The menu button 77 invokes the algorithm which is used to assign attributes to each such contour. The attributes of each object, together with respective textual, graphical, video audio information and associated algorithms are combined in a single data based records and are placed into a data base in the data storage of the computer.

After the data base is created, it is transferred to the data storage of the interactive touch map device. It should be noted that, for convenience, said contours are drawn in a visible color, with different colors for different types of objects for easier identification. However, in the algorithm used in the interactive map device they are drawn and filled with the transparent color.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Interactive touch screen map device for displaying an image representing a map to a user and permitting the user to point to locations and features of the image map, said touch screen computer system comprising, in combination:
a computer with a touch screen display,
an intuitive graphical user interface with means of programming interactive visual elements, an object-oriented event-driven programming means for said user graphical interface,
a memory including means for storing data in an data structure having data elements associated with respective map locations, said data elements including map images for areas associated with said map locations,
said memory also storing interactive objects associated with features of said maps for each of a plurality of maps, thereby defining the content of said image, said image having a plurality of predefined features, said features occurring at certain of said pixel locations associated with said map locations,
said memory also storing respective records of descriptive information for said interactive elements and hereby for said map features, said descriptive information including textual, numerical, video and audio information, said descriptive information including also computer algorithm associated with the said feature,
means for reading said descriptive information for said map features and creating associated transparent and thereby invisible interactive elements at specified pixel locations;
means for associating said pixel location with responsive interactive elements,
means for associating said interactive elements with predefined set of computer system events,
means for executing said computer algorithm responsive to said event associated with said element.

2. Interactive touch screen map device as claimed in claim 1 further comprising Global Positioning System

3. Interactive touch screen map device as claimed in claim 1 further comprising radio networking device

4. Interactive touch screen map device as claimed in claim 1 further comprising audio device

5. Interactive touch screen map device as claimed in claim 1 wherein said GUI includes information and control section, said information and control section includes information display elements, control elements and graphical image elements

6. Interactive touch screen map device for displaying an image representing a map to a user and permitting the user to point to locations and features of the image map, said touch screen system as claimed in claim 1 wherein said interactive elements also include icon-like images

7. Interactive touch screen map device as claimed in claim 6 further comprising means for displaying said icon-like images associated with each of said interactive elements at the pixel locations determined by computer algorithm associated with said interactive element, and means for moving said icon-like images to pixel location determined by said computer algorithm

8. Interactive touch screen map device as claimed in claim 1 wherein said computer system includes computer algorithm for transferring said data structure through networking device set forth in claim 3

9. Interactive touch screen map device as claimed in claim 1 wherein said computer system includes computer algorithm for remote controlling and monitoring of operations of said device through networking device set forth in claim 3

10. A method for programming an interactive touch screen map comprising the steps of:
defining the operational modes and algorithms for switching said operational modes,
associating pixel coordinates of map images with respective map coordinates,
associating interactive objects with map features,
associating interactive said objects with computer system events for each of plurality of said operational modes, associating said objects with descriptive information

11. A method for programming an interactive touch screen map as claimed in claim 10 wherein said programming steps include using a computer program for automating the steps of claim 10, said computer program including a map editor comprising algorithms:
for creating and manipulating map images,
for associating pixel coordinates of said images to map coordinates,
for creating and manipulating interactive objects, creating and manipulating descriptive information records
